(19) United States
(12) Patent Application Publication
(10) Pub. No.: US 2007/0181389 A1
(43) Pub. Date: Aug. 9, 2007

(54) Railway brake disc

(75) Inventors: Roland S. Moore, Spartanburg, SC (US); Peter D. Mathern, Greenville, SC (US); Glyn A. Finch JR., Simpsonville, SC (US)

Correspondence Address: THE WEBB LAW FIRM, P.C., 700 KOPPERS BUILDING, 436 SEVENTH AVENUE, PITTSBURGH, PA, 15219, US

(73) Assignee: Wabtec Holding Corporation, Wilmerding, PA (US)

(21) Appl. No.: 11/348,111

(22) Filed: Feb. 6, 2006

(51) Int. Cl. F16D 65/12

(52) U.S. Cl. 188/218 XL

(57) ABSTRACT

A brake disc comprises a cylindrical hub, two parallel friction rings, and a plurality of spokes joining the hub to the friction rings. The spokes having an I-beam shaped cross section taken parallel to the hub axis.

### BACKGROUND OF THE INVENTION

1. Field of the Invention

The present invention relates to railway brake discs with improved resistance to asymmetrical shock loading.

2. Description of Related Art

The prior art is replete with brake disc designs which generally comprise a hub and two parallel annular discs supported from the hub by spokes. The spokes are normally designed to withstand braking forces, thermal loading, and shock loading due to normal track conditions. However, certain track conditions produce asymmetrical vertical shock loading that stresses the connection between the spokes and the hub. It is an object of this invention to provide a brake disc design that is robust to asymmetrical shock loading.

### SUMMARY OF THE INVENTION

Briefly, according to this invention, in a brake disc comprising a cylindrical hub, two parallel friction rings, and a plurality of spokes joining the hub to the friction rings, the improvement comprises the spokes having a cross section taken parallel to the hub axis that has an I-beam shape.

More specifically, according to a preferred embodiment of this invention, there is provided a brake disc comprising a cylindrical hub having an inner cylindrical surface defined by a hub axis, a given diameter, and a given axial length. The hub has a radial thickness defined by the inner cylindrical surface and an outer generally cylindrical surface. Two friction rings are coaxial with the hub axis and have parallel opposite-facing braking surfaces. The friction rings have an axial thickness defined by the braking surfaces and interior surfaces. Central openings in the friction rings extend from the hub axis and have a diameter greater than the diameter of the outer generally cylindrical surface of the hub. The friction rings have generally circular outer radial edges. A plurality of pairs of spoke flanges extends between the outer generally cylindrical surface of the hub and the friction rings. The spoke flanges have axially extending widths defined by inner and outer faces. Each spoke flange in a pair of spoke flanges is axially spaced and connected with a different friction ring. The spoke flanges have generally radial edges such that edges of the central openings in the friction rings and the edges of the spoke flanges define generally trapezoidal openings between the hub and the friction rings. A plurality of radial spoke webs have a thickness defined by generally flat parallel faces. Each spoke web extends between and joins the hub and both friction rings. Each spoke flange also extends between and joins a single pair of spoke flanges such that a cross section of a spoke web and associated spoke flange pair taken parallel to the hub axis has an I-beam shape.

In a preferred embodiment of this invention, the spoke webs extend from the outer generally cylindrical surface of the hub to near the outer diameter of the friction rings. For example, the spoke webs extend from the outer generally cylindrical surface of the hub to at least three quarters of the distance between the central opening in the friction rings and the outer diameter of the friction rings.

### BRIEF DESCRIPTION OF THE DRAWINGS

Further features and other objects and advantages of this invention will become clear from the following detailed description made with reference to the drawings in which:

FIG. 1 is perspective view of a brake disc according to this invention; and

FIG. 2 is a section view taken perpendicular to the hub axis between the friction rings of a brake disc according to this invention;

FIG. 3 is a view looking along the hub axis of a brake disc according to this invention; and

FIG. 4 is a section view taken along line IV-IV of FIG. 3.

### DESCRIPTION OF THE PREFERRED EMBODIMENTS

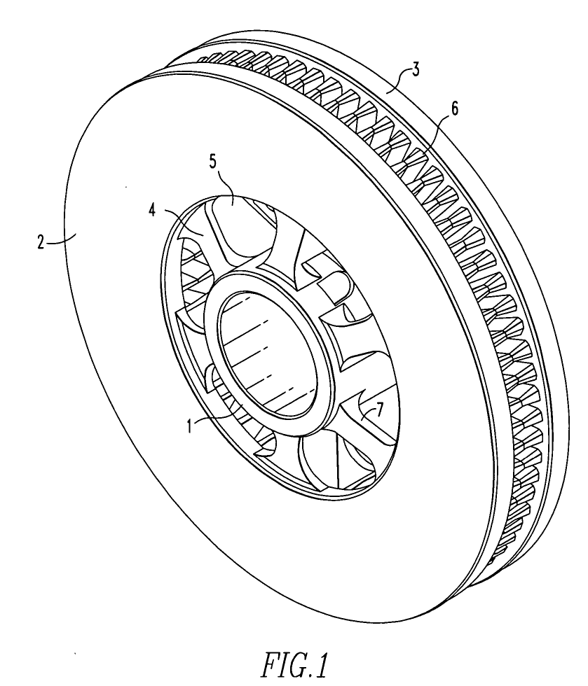

Referring now to FIG. 1, a brake disc according to this invention comprises a cylindrical hub 1, two parallel friction rings 2 and 3, and a plurality of spokes comprised of spoke flanges 4 and spoke webs 5. The spoke flanges 4 and spoke webs 5 are arranged to form six spokes each having an I-beam shaped cross section. Typical of railway brake discs, between the friction rings there is provided a plurality of radially extending cooling fins 6 extending between the interior surfaces of the friction rings 2 and 3.

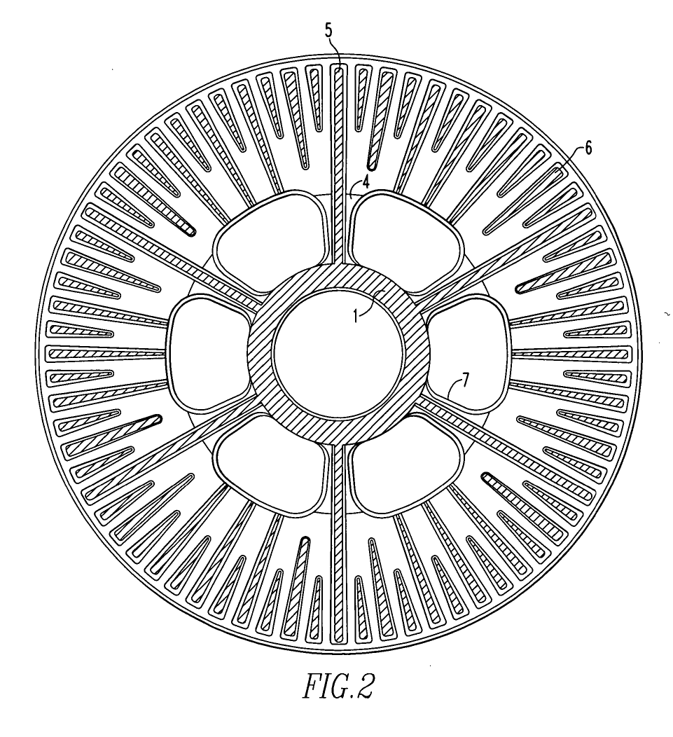

Referring now to FIG. 2, the shape of the spoke flanges 4 is easily observed. The spoke flanges have generally radial edges 7 such that the edges of the central openings in the friction rings and the edges of the spoke flanges define generally trapezoidal openings between the hub 1 and the friction rings 2, 3. The spoke flanges are wider where they join the friction ring than where they join the hub. The edges of the spoke flanges adjacent the friction rings are rounded. The faces of the spoke flanges are inset slightly from the friction surfaces of the friction rings.

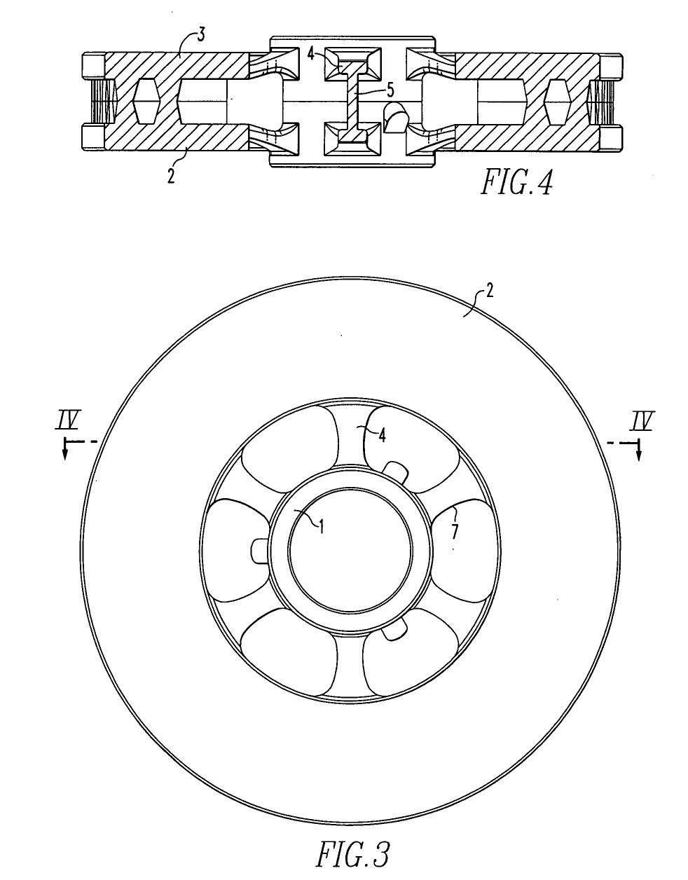

Each spoke web 5 extends between and joins the hub and two friction rings 3, 4 and also extends between and joins a single pair of spoke flanges such that a cross section of a web and associated spoke flange pair taken parallel to the hub axis has an I-beam shape. The I-beam shape of the section of the spoke web and flanges is shown in FIG. 4.

Having thus described our invention in the detail and particularity required by the Patent Laws, what is desired protected by Letters Patent is set forth in the following claims.

1. (canceled)

2. A brake disc comprising:
a cylindrical hub having a rotary axis and having an inner cylindrical surface defined by the rotary axis, a given diameter, and a given axial length, said hub having a radial thickness defined by the inner cylindrical surface and an outer generally cylindrical surface;
two friction rings coaxial with the hub axis having parallel opposite-facing braking surfaces, said friction rings having an axial thickness defined by the braking surfaces and interior surfaces, there being central openings in the friction rings extending from the hub axis and having a diameter greater than the diameter of the outer generally cylindrical surface of the hub, said friction rings having generally circular outer edges;
a plurality of pairs of spoke flanges extending between the outer generally cylindrical surface of the hub and said friction rings, said spoke flanges having axially extending widths defined by inner and outer faces, each spoke flange in a pair of spoke flanges being axially spaced from the other and each spoke flange connected with a different friction ring, the spoke flanges having generally radial edges such that edges of the central openings in the friction rings and edges of the spoke flanges define generally trapezoidal openings between the hub and the friction rings; and
a plurality of radial spoke webs having a thickness defined by generally flat parallel faces, each spoke web extending between and joining the hub and both friction rings such that a cross section of associated flange pairs and webs taken parallel to the hub axis has an I-beam shape.

3. The brake disc according to claim 2, wherein the spoke webs extend from the outer generally cylindrical surface of the hub to near the outer diameter of the friction rings.

4. The brake disc according to claim 2, wherein the spoke webs extend from the outer generally cylindrical surface of the hub to at least three quarters of the distance between the central opening in the friction rings and the outer diameter of the friction rings.

5. The brake disc according to claim 2, wherein the spoke flanges are spaced inwardly of the braking surfaces of the friction rings.

6. The brake disc according to claim 2, wherein the spoke flanges are wider where they join the friction ring than where they join the hub.

7. The brake disc according to claim 2, wherein the edges of the spoke flanges adjacent the friction rings are rounded.

8. The brake disc according to claim 2, wherein the spoke webs are approximately rectangular between the hub and friction rings.

9. The brake disc of claim 2, comprised of a single casting.

10. The brake disc of claim 2, further comprising a plurality of radially extending cooling fins extending between the interior surfaces of the friction rings.
